(19) United States
(12) Patent Application Publication
(10) Pub. No.: US 2009/0154021 A1
(43) Pub. Date: Jun. 18, 2009

(54) Perpendicular magnetic recording head

(76) Inventors: Isao Nunokawa, Kanagawa (JP); Mikito Sugiyama, Kanagawa (JP); Kikuo Kusukawa, Saitama (JP); Hiroyuki Hoshiya, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/313,621

(22) Filed: Nov. 20, 2008

(30) Foreign Application Priority Data
Dec. 14, 2007 (JP) 2007-323747

(51) Int. Cl. G11B 5/60; G11B 5/10

(52) U.S. Cl. 360/234.3; 360/123.12; G9B/5.034; G9B/5.229

(57) ABSTRACT

Embodiments of the present invention provide a magnetic head that can stably supply a perpendicular magnetic field component while generating high recording field strength from a main pole. According to one embodiment, a magnetic body is deposited in a trailing side of a pole tip of a main pole via a nonmagnetic layer, so that a second flare section is magnetically coupled with each sidewall.

### CROSS-REFERENCE TO RELATED APPLICATION

The instant nonprovisional patent application claims priority to Japanese Patent Application No. 2007-323747 filed Dec. 14, 2007 and which is incorporated by reference in its entirety herein for all purposes.

### BACKGROUND OF THE INVENTION

Recently, demand for high surface recording density is increasing, and a track pitch for writing into a magnetic recording medium and bit size are required to be reduced. Along with this, thermal fluctuation of magnetization becomes problematic as a cause of an unstable magnetization region of the medium. As a method that allows such a problem to be solved, a perpendicular magnetic recording method is given, in which a magnetization signal is recorded in a direction perpendicular to the medium. Even in the perpendicular magnetic recording method, a single-pole region for writing, which generates a perpendicular recording field to a medium, is narrowed in order to increase surface recording density, and consequently it is being difficult to generate a sufficient perpendicular magnetic field to magnetize a recording medium.

To compensate such lack of the writing field strength, a method is given, in which throat height is reduced to allow a saturation position of a magnetic field to be close to an air-bearing surface so that certain magnetic field strength is secured. However, the method has a problem that a flare region, which collects a magnetic field generated by induction of a coil, and introduces the magnetic field to the air-bearing surface, is close to an air-bearing surface, consequently recording magnetization width is increased compared with geometric width of a single pole due to field leakage from the flare region.

Thus, as a method of securing magnetic field strength without reducing the throat height, JP-A-2006-244671 discloses obtaining certain magnetic field strength by providing a first portion for exposing a tip end portion of a main pole to an air-bearing surface, and a second portion that is situated at an upper part in an element height direction compared with the first portion, and has a region of which the surface at a leading side is inclined to a head air-bearing surface, and is gradually increased in thickness toward an upside in the element height direction. JP-A-2001-101612 discloses a structure in which a magnetic yoke is disposed at a trailing side of a main pole layer. JP-A-2001-143221 discloses obtaining certain magnetic field strength by operation that a connection section having a width larger than width of a writing pole is provided at a side near an air-bearing surface compared with a throat height zero position of a main pole, so that a saturation position of magnetic flux is shifted to an air-bearing surface side.

In order to improve recording performance of a magnetic disk drive using the perpendicular magnetic recording method, a writing head for recording needs to generate a magnetic field strength necessary for writing into a recording medium and high field gradient. Moreover, a main-pole layer for writing needs to be secured in the flow of magnetic flux for stably supplying a perpendicular magnetic field from an air-bearing surface to a recording medium. However, the single-pole head for perpendicular recording is narrowed in shape at an air-bearing surface side to meet the demand for high density recording, which makes it difficult to supply sufficient magnetic field strength to the recording medium. As a method of increasing magnetic field strength, a method is given, in which a magnetic body is deposited in a trailing side or a leading side at a position retracted from an air-bearing surface of the main pole so as to form an auxiliary pole which supplies auxiliary magnetic flux to the main pole, thereby increasing the magnetic field strength While magnetic field strength can be increased by the method, the method has a problem that magnetic flux flows into a main-pole layer from a region near a tip end portion at an air-bearing surface side of the auxiliary pole, which interferes with a flow of the magnetic flux, and the main pole is affected thereby.

### BRIEF SUMMARY OF THE INVENTION

Embodiments of the present invention provide a magnetic head that can stably supply a perpendicular magnetic field component while generating high recording field strength from a main pole. According to the embodiment shown in FIGS. 2(a) and 2(b), a magnetic body is deposited in a trailing side of a pole tip 1a of a main pole 1 via a nonmagnetic layer 6, so that a second flare section 5 magnetically coupled with each sidewall is provided.

### BRIEF DESCRIPTION OF THE DRAWINGS

FIGS. 1(a) and 1(b) show a schematic diagram of a magnetic recording/reproducing apparatus.

FIGS. 2(a) and 2(b) show a schematic section diagram and an expanded diagram at a track center of an example of a magnetic head according to an embodiment of the invention.

FIGS. 3(a) and 3(b) show a schematic plane diagram and a schematic section diagram of a main pole portion of the example of the recording head according to an embodiment of the invention.

FIG. 4 shows an expanded diagram of a recording head of a comparative example.

FIG. 5 shows an expanded diagram of a recording head of another comparative example.

FIGS. 6(a)-6(c) show schematic diagrams showing flows of magnetic flux.

FIG. 7 shows a diagram showing a relationship between amount of increase in magnetic field and film thickness of a second flare section.

FIGS. 8(a) and 8(b) show diagrams showing change in magnetic field strength and change in field gradient depending on a position of the second flare section.

FIGS. 9(a) and 9(b) show diagrams showing change in amount of increase in magnetic field and change in field gradient depending on thickness of a nonmagnetic layer for magnetically separating between the second flare section and a main pole.

FIGS. 10(a) and 10(b) show diagrams showing a manufacturing process of the recording head of an embodiment of the invention.

FIGS. 11(a)-11(c) show diagrams showing the manufacturing process of the recording head of an embodiment of the invention.

FIGS. 12(a)-12(c) show diagrams showing the manufacturing process of the recording head of an embodiment of the invention.

FIGS. 13(a)-13(c) show diagrams showing a manufacturing process of a recording head of an embodiment of the invention.

FIGS. 14(a)-14(c) show diagrams showing a manufacturing process of a recording head of an embodiment of the invention.

FIGS. 15(a)-I 5(c) show diagrams showing the manufacturing process of the recording head of an embodiment of the invention.

FIGS. 16(a)-16(c) show diagrams showing the manufacturing process of the recording head of an embodiment of the invention.

FIGS. 17(a) and 17(b) shows schematic diagrams showing a second flare section having a tapered shape.

### DETAILED DESCRIPTION OF THE INVENTION

Embodiments of the present invention relate to a magnetic head for a magnetic disk drive using a perpendicular magnetic recording method, and particularly relate to a perpendicular magnetic recording head that generates a recording field perpendicular to a recording medium.

An object of embodiments of the invention is to provide a perpendicular magnetic recording head, by which writing field strength is increased without affecting a flow of magnetic flux in a main pole, and field gradient is increased, leading to improvement in recording performance, and provide a manufacturing method of the perpendicular magnetic recording head.

A perpendicular magnetic recording head of an embodiment of the invention has a main pole that applies a magnetic field in a perpendicular direction to a recording medium, an auxiliary pole that absorbs a return field from the recording medium, a coil that allows the main pole to generate an induction field, and a shield disposed at a trailing side of the main pole and at both sides in a track width direction thereof. The main pole includes a yoke section that collects magnetic flux, a throat height region that defines writing/recording width, and a flare section that is situated in an upper part in an element height direction with respect to the throat height region, and gradually expands in width toward an upside in the element height direction, wherein a magnetic layer is coated in a trailing side of the flare section of the main pole via a non magnetic layer so as to be formed into a second flare section. Part of the magnetic layer of the second flare section is coupled with sidewalls of the main pole. Magnetic flux in the second flare section flows in the same direction as a flow of magnetic flux in the main pole.

A feature of the perpendicular magnetic recording head according to an embodiment of the invention is that the magnetic layer (second flare section) is provided in a trailing side of the main pole via the non magnetic layer. In the case of a single-pole-type main pole, magnetic flux leaks from a surface at a trailing side of the main pole before the magnetic flux arrives at an air-bearing surface. However, the second flare section is provided via a nonmagnetic body as in the invention, thereby magnetic flux in the trailing side region of the main pole flows parallel to magnetic flux in a leading side of the second flare section provided via the nonmagnetic layer, and flows toward the air-bearing surface while magnetic flux leakage is suppressed. Auxiliary field enhancement is given by the second flare section while keeping magnetic field strength of the main pole, thereby the main pole emits a high magnetic field from the air-bearing surface, and thus can perform writing into a recording medium.

In manufacturing the perpendicular magnetic recording head of embodiments of the invention, the following steps are used, that is, a step that a nonmagnetic layer is deposited on a nonmagnetic cap layer in a trailing side of a main pole layer, an etching mask layer is deposited thereon, the etching mask layer is selectively exposed by photolithography, and the etching mask layer is formed by using ion milling, RIM (Reactive Ion Milling), or RIE (Reactive Ion Etching), and a step that the nonmagnetic layer, nonmagnetic cap layer, and main pole layer are sequentially formed by ion milling using the etching mask layer. An ion incidence angle is specified to be, for example, in a range of 30 degrees to 70 degrees. The nonmagnetic layer is formed by, for example, a single-layer film or a multi-layer film of an oxide or a nitride of Al, Si, Ta, Ti or the like, or a single-layer film or a multi-layer film of a nonmagnetic metal of Cr, NiCr, Rh, Mo, Nb, Au or the like. For the etching mask layer, for example, a single-layer film of a hard mask layer using a single-layer film or a multi-layer film of an oxide or a nitride of Al, Si, Ta, Ti or the like, or a single-layer film of a photo resist, or two-layer film of the hard mask layer and the photo resist is used. The etching mask layer is removed, so that the main pole is formed. A two-layer photo resist mask for liftoff is formed on the nonmagnetic layer in a trailing side of the formed main pole, an opening is formed by photolithography such that the opening has a larger width than width of a flare section of the main pole, and a magnetic body is deposited using a sputtering method such that it coats sidewalls and a surface of the main pole. Through a step of removing the two-layer photo resist mask for liftoff, a second flare section is formed on a flare section in the trailing side of the main pole. The second flare section is formed of, for example, a magnetic material containing at least two elements of Co, Ni and Fe.

According to embodiments of the invention, the main pole of the perpendicular magnetic recording head is supplied with an auxiliary magnetic field by the second flare section, so that writing field strength of the main pole can be increased. Due to such increase in magnetic field strength, writing blur that affects recording performance is suppressed, and even if magnetic field strength is reduced due to narrowing a gap space between the shield and the main pole, the gap space having influence on field gradient, a magnetic field necessary for writing into a recording medium can be kept. When a magnetic body of an auxiliary pole is directly deposited on a magnetic body of a main pole layer, magnetic flux flows from an end of the auxiliary pole into the main pole, and consequently field gradient being one recording performance is reduced. In embodiments of the invention, the nonmagnetic layer is inserted between the main pole layer and the second flare section, thereby in the main pole, the trailing side of the main pole is magnetically separated from the second flare section, and for a flow of magnetic flux in the main pole, flowing of magnetic flux from the second flare section into the main pole is suppressed by the nonmagnetic layer, and consequently a magnetic recording head having high field gradient can be provided without interfering with the flow of magnetic flux in the main pole.

Hereinafter, particular embodiments of the invention will be described with reference to drawings. In description with the following figures, the same functional parts are marked with the same signs respectively.

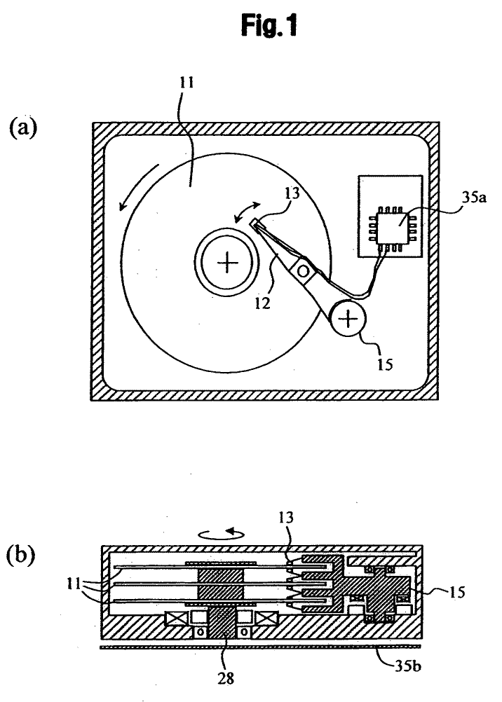

FIGS. 1(a) and 1(b) show conceptual diagrams of a magnetic recording/reproducing device. A magnetic disk (recording medium) 11 is rotationally driven by a motor 28. When information is inputted or outputted, a slider 13 fixed to a tip of a suspension arm 12 is moved onto a predetermined position on a rotating magnetic disk (recording medium) 11 so that recording and reproducing of a magnetization signal is performed by a thin film magnetic head formed on the slider 13. A rotary actuator 15 is driven, thereby a position (track) of the magnetic head in a radial direction of the magnetic disk can be selected. A writing signal into the magnetic head and a reading signal from the magnetic head are processed by signal processing circuits 35a and 35b.

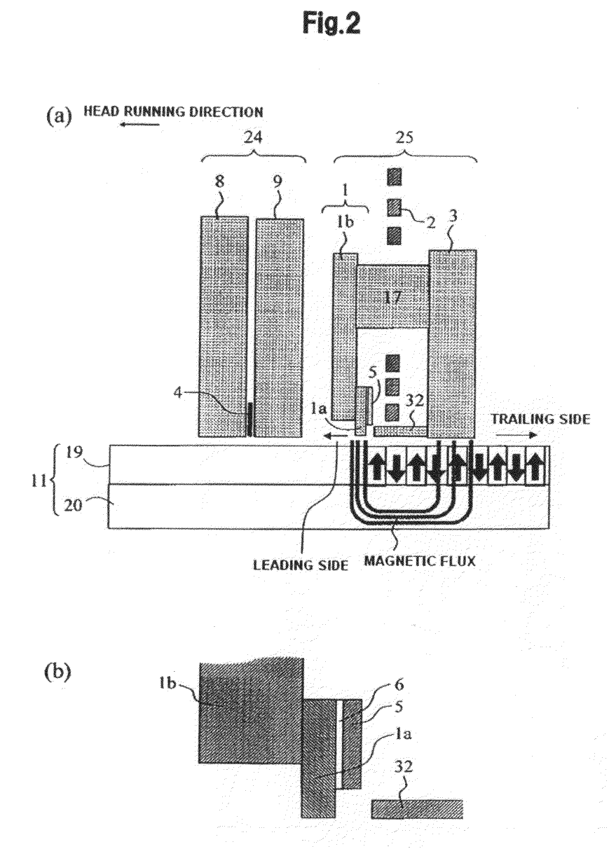

FIG. 2(a) shows a schematic section diagram at a track center, showing an example of a magnetic head according to an embodiment of the invention. FIG. 2(b) shows an expanded diagram of a region near an end of a main pole. The magnetic head is a recording/reproducing combined head having a single-pole recording head 25 having a main pole 1 and an auxiliary pole 3, and a reproducing head 24 having a read element 4. The read element 4 including a giant magneto resistance effect element (GMR) or a tunnel magneto resistance effect element (TMR) is disposed between a pair of magnetic shields (write shield) including a lower shield 8 at a leading side and an upper shield 9 at a trailing side. The main pole 1 and the auxiliary pole 3 of the recording head 25 are magnetically connected by a pillar 17 at a position away from an air-bearing surface, and a thin film coil 2 is circuited by a magnetic circuit configured by the main pole 1, auxiliary pole 3, and pillar 17. The main pole 1 is configured by a main-pole yoke section 1b connected to the pillar 17, and a pole tip 1a. For the pole tip 1a of the main pole, for example, a single-layer film or a multi-layer film of a magnetic body having high saturation magnetic flux density can be used, which includes at least two elements of Co, Ni and Fe. As a material of the main-pole yoke section I b, for example, a magnetic material containing at least two elements of Co, Ni and Fe can be used.

The pole tip 1a has a throat height region at a head air-bearing surface side, which defines width of writing into the recording medium 11, a flare section that is withdrawn from the air-bearing surface and expands in a width direction at an angle of 90°, and a second flare section 5 including a magnetic layer coated in a trailing side and lateral sides of the flare section. The second flare section 5 is provided via a nonmagnetic layer 6 at the trailing side of the flare section of the pole tip 1a, and is directly bonded to each sidewall of the flare section. For a material of the nonmagnetic layer 6, a single-layer film or a multi-layer film of an oxide or a nitride of Al, Si, Ta, Ti or the like, or a single-layer film or a multi-layer film of nonmagnetic metal such as Cr, NiCr, Rh, Mo, Nb and Au can be used. For a material of the second flare section 5, for example, a single-layer film or a multi-layer film of a magnetic material or the like can be used, the magnetic material including at least two elements of Co, Ni, and Fe. Auxiliary field enhancement is applied to the main pole 1 by the magnetic body coated as the second flare section 5.

A magnetic field generated from the main pole 1 of the recording head 25 enters the auxiliary pole 3 through a magnetic recording layer 19 and a soft under layer (SUL) 20 of the magnetic recording medium 11, thereby a magnetization pattern is recorded in the magnetic recording layer 19. The magnetization pattern is defined by writing performance of the main pole 1 and a shield 32 provided at the air-bearing surface side. According to a main pole structure of an embodiment of the invention, leakage of magnetic flux from a side of the main pole 1 in a track width direction is suppressed, so that field gradient at the trailing side of the main pole 1 is increased so as to reduce bit transition width, thereby high recording density can be achieved.

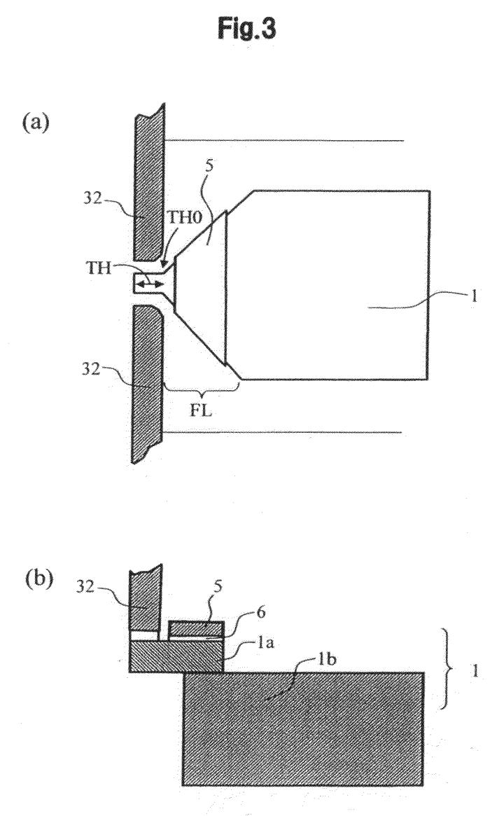

FIG. 3 shows portions of the second flare section 5, main pole 1 and shield 32 of the perpendicular magnetic recording head shown in FIG. 2, wherein FIG. 3(a) shows a planar shape of the portions, and FIG. 3(b) shows a sectional shape thereof. Here, the throat height region refers to a range TH beginning at the air-bearing surface, which defines writing width of the main pole. A boundary line between the range TH and a range, in which width of the main pole is gradually reduced up to the writing width with approaching the air-bearing surface, is assumed to be throat height zero TH0. The flare section refers to a range FL up to the boundary line (throat height zero) with the throat height that defines the writing width, in which a large width portion in a depth direction of the main pole is gradually reduced up to the writing width towards the air-bearing surface.

As shown in FIGS. 3(a) and 3(b), the trailing side and the lateral side of the pole tip 1a of the main pole 1 are surrounded from three sides by the shield 32 via a nonmagnetic gap layer. Magnetic flux emitted from the air-bearing surface side of the pole tip 1a of the main pole 1 is suppressed by the shield 32 in leakage of magnetic flux of the magnetic recording medium 11 in the track width direction, so that field gradient at the trailing side of the main pole 1 is increased so as to reduce bit transition width. A shape of the air-bearing surface of the pole tip 1a of the main pole 1 is an inverted trapezoidal shape that is large in width at the trailing side, and small in width at the leading side. When the magnetic recording medium 11 is scanned from the inside to the outside of the medium, the recording head takes a different angle with respect to a recording track depending on a position of the recording medium. This is called skew angle θ. The purpose for the design that the shape of the air-bearing surface of the main pole 1 is made to be the inverted trapezoidal shape is to prevent a phenomenon that when the skew angle θ is formed, a large magnetic field is applied to an adjacent track, as a result, data in the adjacent track is attenuated or erased.

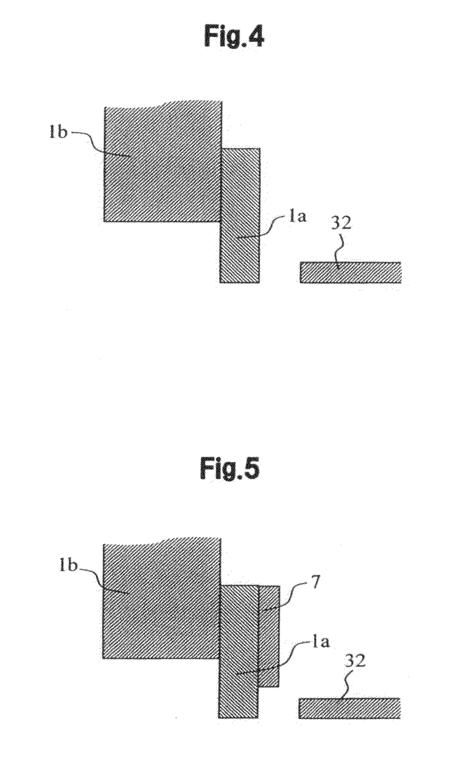

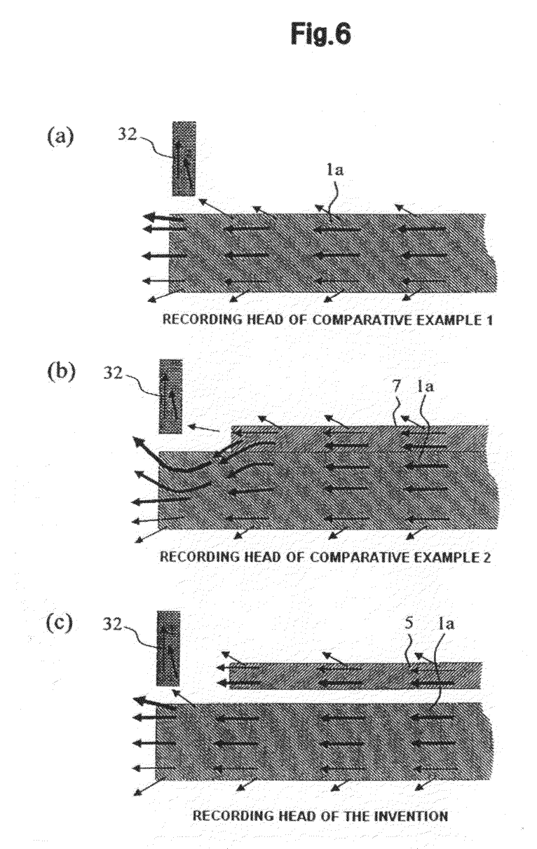

FIGS. 6(a)-6(c) show schematic diagrams showing a flow of magnetic flux toward the air-bearing surface of the main pole. The air-bearing surface is shown in the left of the figure. FIG. 6(a) shows a schematic diagram in the case of a single-pole recording head in a previous structure, FIG. 6(b) shows a schematic diagram in the case of a recording head in which a magnetic layer is directly deposited at a trailing side of a main pole layer, and FIG. 6(c) shows a schematic diagram in the case of a recording head of the invention. Arrows in the figure show a flow of magnetic flux, and magnetic flux density is indicated by thickness of each line. FIG. 4 shows a partial enlarged diagram of the single-pole recording head in the previous structure, which corresponds to FIG. 6(a). FIG. 5 shows a partial enlarged diagram of the recording head in which the magnetic layer is directly deposited at the trailing side of the main pole layer, which corresponds to FIG. 6(b). Hereinafter, the recording head shown in FIG. 4 is called recording head of comparative example 1, and the recording head shown in FIG. 5 is called recording head of comparative example 2.

As shown in FIG. 6(a), in the case of the recording head of the comparative example I, magnetic flux flowing in the pole tip 1a flows in the same direction in each region to neighborhood of the air-bearing surface. A leakage field is generated at the periphery of the pole tip 1a. Part of magnetic flux near the trailing side is gradually absorbed by the shield 32 as the magnetic flux approaches the shield 32 provided at the trailing side of the pole tip 1a at the air-bearing surface side. Magnetic flux other than the relevant magnetic flux flows to the recording medium through the air-bearing surface so as to induce reversal of magnetization in the recording medium. The amount of change in magnetic field (field gradient) per unit length in a moving direction of the recording medium affects recording performance. In the case of the recording head of the comparative example 2 shown in the FIG. 6(b), magnetic flux flowing in the magnetic layer 7 directly deposited on the pole tip 1a is branched at a tip end portion at the air-bearing surface side into magnetic flux being absorbed by the shield 32 and magnetic flux flowing into a pole tip 1a magnetically coupled with the magnetic layer. The magnetic flux flowing into the pole tip 1a once pushes down other magnetic flux flowing in the pole tip 1a, then emitted from the air-bearing surface into the recording medium. The emitted magnetic flux is lost in a component perpendicular to the recording medium, and the magnetic flux expands to the trailing side of the pole tip 1a, consequently field leakage occurs at a side of a recording medium facing the shield 32. The field leakage decreases the total amount of change in magnetic field, which affects the field gradient.

In the case of the recording head of an embodiment of the invention shown in FIG. 6(c), a flow of magnetic flux in the second flare section 5 is the same as the flow of magnetic flux in the pole tip 1a. Magnetic flux flowing near the trailing side of the pole tip 1a flows parallel to magnetic flux near a leading side of the second flare section 5, so that the leakage field at the trailing side of the pole tip 1a is suppressed, and a leakage field mostly occurs from a trailing side of the second flare section 5. Since a magnetic body of the second flare section 5 is deposited at the trailing side of the pole tip 1a via a nonmagnetic layer, the magnetic flux in the second flare section 5 does not flow into the pole tip 1a, and flows in a direction of the shield and in a direction of the air-bearing surface. That is, while a flow of magnetic flux in the main pole 1 is not affected, an auxiliary magnetic field can be enhanced, and a magnetic field component perpendicular to the recording medium can be increased, therefore field gradient is increased.

For example, in the recording head of an embodiment of the invention as shown in FIGS. 2(a) and 2(b), a stable flow of magnetic flux and an increased writing field are obtained, therefore when the recording head is applied with the same writing field strength as in the recording head of the comparative example 1, an applied current into a thin film coil can be reduced. Therefore, heat generation is suppressed, and therefore deformation of the air-bearing surface is suppressed, the deformation being caused by thermal expansion of a member used for the recording head. As a result, low flying amount is stably obtained, a distance between the recording layer of the recording medium and the air-bearing surface of the recording head is decreased, and the field gradient is increased, consequently performance as a perpendicular magnetic recording head is improved. Moreover, field strength is increased, thereby the pole tip 1a for writing into a recording medium can be narrowed while keeping a magnetic field necessary for writing into the recording medium, therefore a magnetic recording head in high recording density can be produced.

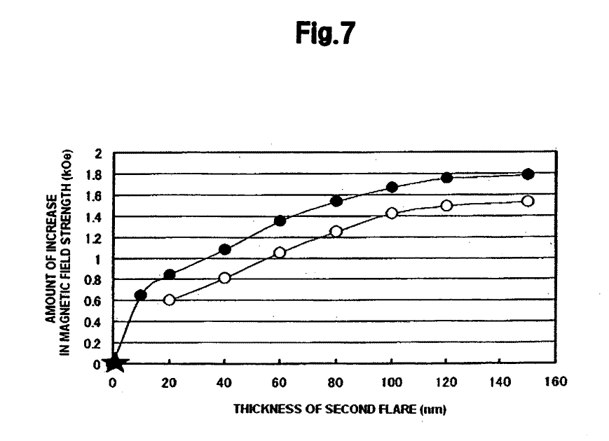

For the recording head of embodiments of the invention, recording head of the comparative example 1, and recording head of the comparative example 2, recording field strength was calculated by three-dimensional magnetic field calculation. FIG. 7 shows a result of calculation of a relationship between amount of increase in magnetic field and thickness of a coated magnetic film.

A calculation condition is as follows. In the main pole 1 of the recording head of the invention, the air-bearing surface side of the throat height of the pole tip 1a was made such that width was 80 nm, film thickness was 180 nm, an angle corresponding to the skew angle θ was 9°, and width at the leading side was narrow, and width at the trailing side was wide so that an inverted trapezoidal shape was formed, and throat height to the air-bearing surface was 80 nm, and the flare section extended to each point 4.9 μm distant from the throat height zero. A lower end of the second flare section S was assumed to be at a position 100 nm distant from the throat height zero in an element height direction, and at a position 180 nm distant from the air-bearing surface. As a material of each of the pole tip 1a and the second flare section 5 of the main pole, cobalt-nickel-iron (CoNiFe) was supposed, wherein saturation magnetic flux density was 2.4 T and relative permeability was 500. A material of the nonmagnetic layer inserted to separate the pole tip 1a from the second flare section 5 was assumed to be alumina (Al₂O₃), of which the thickness was 20 nm. Taking into account a fact that the magnetic body configuring the second flare section 5 is deposited on sidewalls of the pole tip 1a, the second flare section 5 was assumed to be large in width compared with the flare section by a level corresponding to thickness of the coated magnetic body.

An end in the element height direction of the pole tip 1a was assumed to be at the same position as an end in the element height direction of the second flare section 5. For the yoke section 1b of the main pole, 80 at % Ni-20 at % Fe having saturation magnetic flux density of 1.0 T and relative permeability of 1500 was supposed to be used. For the shield 32, 80 at % Ni-20 at % Fe having saturation magnetic flux density of 1.0 T and relative permeability of 1500 was supposed to be used, and it was assumed that the shield had a height from the air-bearing surface (in a depth direction) of 80 nm, and surrounded the pole tip from three sides via alumina of a nonmagnetic gap layer. CoTaZr was supposed as a material of a backing layer 20 of the magnetic recording medium 11, wherein a distance from the head air-bearing surface to a surface of the backing layer 20 was 44 nm, and thickness of the backing layer 20 was 60 nm. A recording field was calculated at a position being supposed as a central position of a magnetic recording layer 22 nm distant from the head air-bearing surface. Regarding the medium recording layer, only thickness of 20 nm was considered, and magnetization properties were not considered.

For the recording head of the comparative example 1, calculation was made at the same condition as in the recording head shown in FIGS. 2(a) and 2(b) in both a shape and a material except that the second flare section 5 was not present. For the recording head of the comparative example 2, calculation was made at the same condition as in the recording head shown in FIGS. 2(a) and 2(b) in both a shape and a material except that the magnetic body 7 was deposited on the flare section at the trailing side of the pole tip 1a of the main pole 1.

A horizontal axis of FIG. 7 corresponds to thickness of the magnetic body of the second flare section 5 of the recording head of an embodiment of the invention. For the recording head-of the comparative example 2, the horizontal axis corresponds to thickness of the magnetic body 7 deposited on the flare section at the trailing side of the pole tip 1a of the main pole 1. In the case of this condition, a case that thickness of the coated magnetic body is zero corresponds to the recording head of the comparative example 1. A vertical axis shows increase in amount of magnetic field strength of each of the recording head of the invention and the recording head of the comparative example 2 with respect to the recording head of the comparative example 1. In the figure, a star shows a calculation result for the recording head of the comparative example 1, open circles show a calculation result for the recording head of the comparative example 2, and black circles show a calculation result for the recording head of the invention. Magnetic field strength of the recording head of the comparative example 1 is 10.23 kOe.

The recording head of an embodiment of the invention is large in increased amount of magnetic field strength compared with the recording head of the comparative example 2 while the magnetic body is deposited via alumina (Al₂O₃) of the nonmagnetic layer 6. The reason why the increased amount of magnetic field strength is large is because increased amount of a magnetic field is added, which is caused by a fact that the second flare section 5 covers even the sidewalls of the pole tip 1a. For example, when the gap between the pole tip 1a and the shield 32 enclosing the three sides of the pole tip is reduced by 10 nm in order to increase field gradient by 20%, magnetic field strength is reduced by 7%, and therefore the recording head of the comparative example 1 cannot secure the writing field into the recording medium. However, even in such a case, the recording head of an embodiment of the invention and the recording head of the comparative example 2 can adequately secure the writing field into the recording medium since they essentially have high magnetic field strength. While magnetic field strength is increased in proportion to thickness of the coated magnetic body, when thickness of the magnetic body exceeds a certain value, an increasing rate of magnetic field strength is decreased. According to FIG. 7, thickness of the magnetic body on the second flare section 5 may be 10 nm, at or above which the field enhancement effect is found, to 150 nm, at which increasing tendency of the magnetic field is reduced.

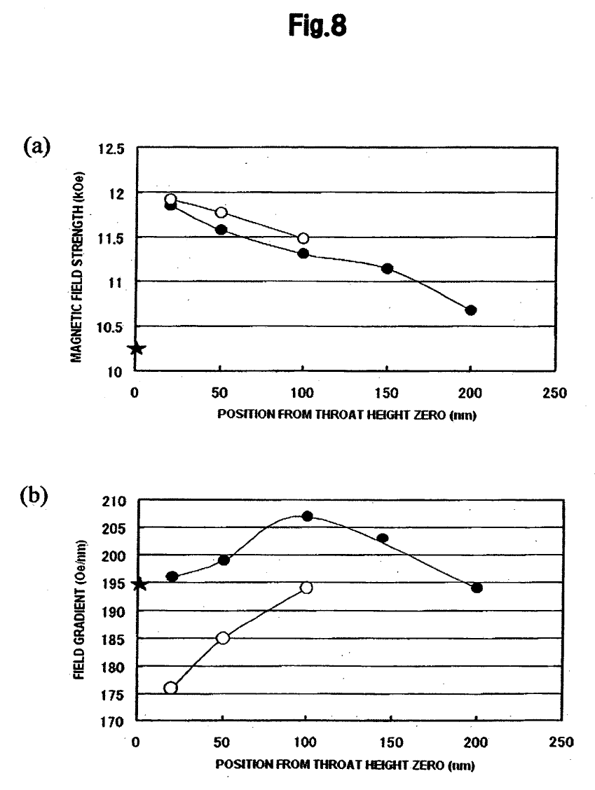

FIGS. 8(a) and 8(b) show a relationship between a lower end position of the second flare section of the recording head of the invention and each of magnetic field strength and field gradient. Calculation results for the recording head of the comparative example 1 and the recording head of the comparative example 2 are shown together.

A calculation condition is as follows. In the main pole 1 of the recording head of an embodiment of the invention, the air-bearing surface side of the throat height of the pole tip 1a was made such that width was 80 nm, film thickness was 180 nm, an angle corresponding to the skew angle θ was 9°, and width at the leading side was narrow, and width at the trailing side was wide so that an inverted trapezoidal shape was formed, and throat height to the air-bearing surface was 80 nm, and the flare section extended over an area from the throat height zero to each point 4.9 μm distant from there. Calculation was made while a lower end position of the second flare section 5 was moved in a range from a position of the throat height zero to a position 200 nm distant from there in an element height direction. As a material of each of the pole tip 1a and the second flare section 5 of the main pole, cobalt-nickel-iron (CoNiFe) was supposed, wherein saturation magnetic flux density was 2.4 T and relative permeability was 500. A material of the nonmagnetic layer inserted between the trailing side of the pole tip 1a and the second flare section 5 was assumed to be alumina (Al₂O₃), of which the thickness was 20 nm, and thickness of the magnetic body of the second flare section 5 was assumed to be 40 nm. Taking into account a fact that the magnetic body is deposited on left and right sidewalls of the pole tip 1a, the second flare section 5 was assumed to have a width 80 nm larger than width of the flare section. An end position in the element height direction of the pole tip 1a was assumed to be the same as an end position in the element height direction of the second flare section 5.

For the yoke section 1b of the main pole 1, 80 at % Ni-20 at % Fe having saturation magnetic flux density of 1.0 T and relative permeability of 1500 was supposed to be used. For the shield 32, 80 at % Ni-20 at % Fe having saturation magnetic flux density of 1.0 T and relative permeability of 1500 was supposed to be used, and it was assumed that the shield had a height from the air-bearing surface (in a depth direction) of 80 nm, and surrounded the pole tip from three sides via alumina of a nonmagnetic gap layer. CoTaZr was supposed as a material of the backing layer 20 of the magnetic recording medium 11, wherein a distance from the head air-bearing surface to a surface of the backing layer 20 was 44 nm, and thickness of the backing layer 20 was 60 nm. A recording field was calculated at a central position of a magnetic recording layer 22 nm distant from the head air-bearing surface. Regarding the medium recording layer, only thickness of 20 nm was considered, and magnetization properties were not considered.

A horizontal axis of each of FIGS. 8(a) and 8(b) corresponds to a position from the throat height zero of a tip end portion at the air-bearing surface side of the second flare section 5 in the case of the recording head of an embodiment of the invention, and a position from the throat height zero of the magnetic body 7 deposited on a surface of the trailing side of the main pole layer in the case of the recording head of the comparative example 2. In the figure, each star shows a calculation result for the recording head of the comparative example 1, open circles show a calculation result for the recording head of the comparative example 2, and black circles show a calculation result for the recording head of an embodiment of the invention.

In the case of the recording head of the comparative example 2, as shown in FIG. 8(a), as an end at the air-bearing surface side of the deposited magnetic body 7 approaches the throat height zero, magnetic field strength of the main pole 1 is increased. On the contrary, field gradient shown in FIG. 8(b) tends to be reduced as the end at the air-bearing surface side of the deposited magnetic body 7 approaches the throat height zero. A cause of reduction in field gradient is that magnetic flux near the tip end portion of the deposited magnetic body 7 flows into the pole tip 1a, which affects a flow of magnetic flux in the pole tip 1a, and therefore interferes with perpendicular magnetic field distribution, as shown in FIG. 6(b). When the end at the air-bearing surface side of the deposited magnetic body 7 is disposed at a position 100 nm distant from the throat height zero in the element height direction, while the flow of the magnetic flux is restored before arriving at the air-bearing surface, influence of such magnetic flux becomes larger as the magnetic flux approaches the air-bearing surface, resulting in reduction in field gradient.

In the case of the recording head of an embodiment of the invention, as shown in FIG. 8(b), when a lower end position of the second flare section 5 is disposed at a position 20 nm distant from the throat height zero of the pole tip 1a in the element height direction, the recording head has the same field gradient as field gradient of the recording head of the comparative example 1, and the field gradient is increased until the lower end position of the second flare section 5 is withdrawn to a position 100 nm distant from the throat height zero in the element height direction, the field gradient having a maximum value at the 100 nm distant position. After that, when the lower end position of the second flare section 5 is further withdrawn, magnetic field strength is reduced, in addition, field gradient tends to be reduced. When the second flare section 5 exists near the throat height zero, magnetic flux in the second flare section 5 is absorbed by the shield 32 provided at the air-bearing surface side, so that field leakage from the shield is increased, leading to reduction in field gradient. As the second flare section 5 recedes from the shield 32, field leakage from the shield is decreased, leading to increase in field gradient.

From the calculation results of FIGS. 8(a) and 8(b), when an effect of magnetic field enhancement and field gradient are considered, to obtain the field enhancement effect, a setting position of the tip end portion at the air-bearing surface side of the second flare section 5 may be in a range of a position 20 nm distant from the throat height zero in the element height direction to a position 200 nm distant from there, at which field gradient is reduced to the same field gradient as in the recording head of the comparative example 1.

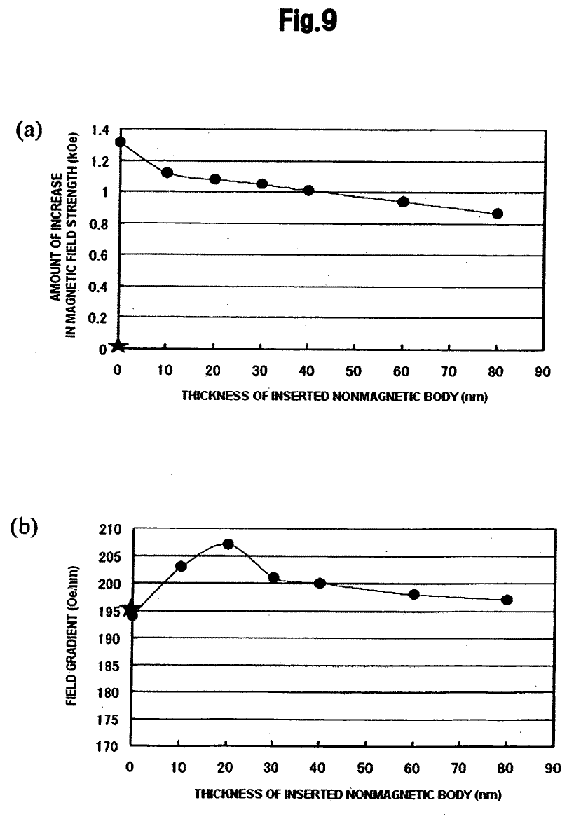

FIGS. 9(a) and 9(b) show change in magnetic field strength and change in field gradient with respect to thickness of the nonmagnetic layer for magnetically separating between the second flare section 5 and the main pole.

A condition of such calculation is as follows. In the main pole 1 of the recording head of the invention, the air-bearing surface side of the throat height of the pole tip 1a was made such that width was 80 nm, film thickness was 180 nm, an angle corresponding to the skew angle θ was 9°, and width at the leading side was narrow, and width at the trailing side was wide so that an inverted trapezoidal shape was formed, and throat height to the air-bearing surface was 80 nm. The flare section was made to extend over an area from the throat height zero to each point 4.9 μm distant from there. Calculation is made assuming that an end position at the air-bearing surface side of the second flare section 5 is 100 nm distant from the position of the throat height zero in the element height direction. As a material of each of the pole tip 1a and the second flare section 5 of the main pole, cobalt-nickel-iron (CoNiFe) was supposed, wherein saturation magnetic flux density was 2.4 T and relative permeability was 500. A material of the nonmagnetic layer inserted between the trailing side of the pole tip 1a and the second flare section 5 was assumed to be alumina (Al₂O₃), and calculation was made while thickness of the nonmagnetic layer was changed from 0 nm to 60 nm. In thickness of 0 nm, the pole tip 1a was coated by the magnetic body of the second flare section 5 in a condition that the nonmagnetic layer was not inserted between them.

Thickness of the second flare section 5 was assumed to be 40 nm. Taking into account a fact that the magnetic body is deposited on left and right sidewalls of the pole tip 1a, the second flare section 5 was assumed to have a width 80 nm larger than width of the flare section of the pole tip. An end position in the element height direction of the pole tip 1a was assumed to be the same as an end position in the element height direction of the second flare section. For the yoke section 1b of the main pole 1, 80 at % Ni-20 at % Fe having saturation magnetic flux density of 1.0 T and relative permeability of 1500 was supposed to be used. For the shield 32, 80 at % Ni-20 at % Fe having saturation magnetic flux density of 1.0 T and relative permeability of 1500 was supposed, and it was assumed that the shield had a height from the air-bearing surface (in a depth direction) of 80 nm, and surrounded the pole tip from three sides via alumina of a nonmagnetic gap layer. CoTaZr was supposed as a material of the backing layer 20 of the magnetic recording medium 11, wherein a distance from the head air-bearing surface to a surface of the backing layer 20 was 44 nm, and thickness of the backing layer 20 was 60 nm. A recording field was calculated at a central position of a magnetic recording layer 22 nm distant from the head air-bearing surface. Regarding the medium recording layer, only thickness of 20 nm was considered, and magnetization properties were not considered.

A horizontal axis of each of FIGS. 9(a) and 9(b) corresponds to thickness of the nonmagnetic body 6 for magnetically separating between the trailing side of the pole tip I a and the second flare section 5. A vertical axis of FIG. 9(a) shows amount of increase in magnetic field with respect to magnetic field strength of the recording head of the comparative example 1. A vertical axis of FIG. 9(b) shows field gradient. In the figure, each star shows a calculation result for the recording head of the comparative example 1, and black circles show a calculation result for the recording head of an embodiment of the invention. Magnetic field strength of the recording head of the comparative example 1 is 10.23 kOe.

In the case of this condition, in a condition where the nonmagnetic body 6 is not present, while the amount of increase in magnetic field strength is large, field gradient is low. That is, in the condition where the nonmagnetic body 6 is not present, as shown in FIG. 6(b), magnetic flux near the tip end portion of the deposited magnetic body flows into the pole tip, which affects a flow of other magnetic flux in the pole tip, therefore field gradient is reduced. When the nonmagnetic body 6 is designed to be 10 nm to 80 nm in thickness, the field enhancement effect and the field gradient can be set high compared with the recording head of the comparative example 1.

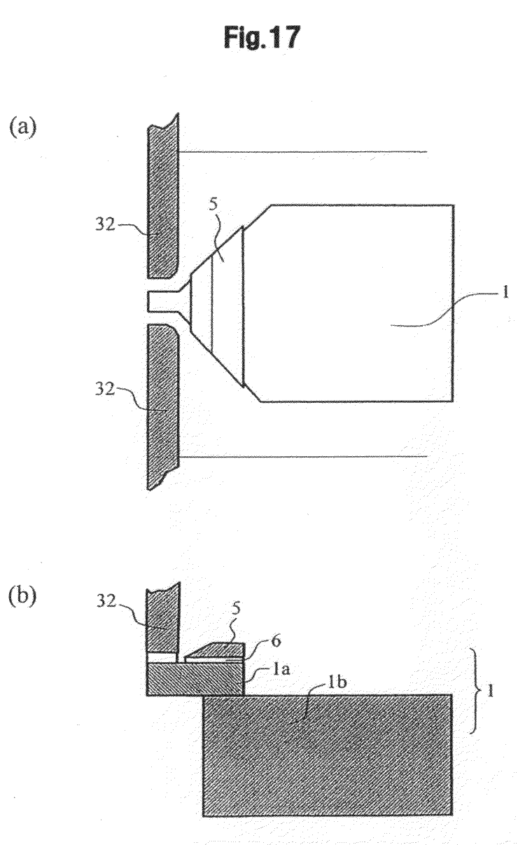

While a shape of the tip end portion at the air-bearing surface side of the second flare section 5 was described to be parallel to the air-bearing surface as shown in FIGS. 2 and 3 hereinbefore, even if the tip end portion has a tapered shape where thickness of a magnetic body is increased from the air-bearing surface at the trailing side of the second flare section 5 in the element height direction as shown in FIGS. 17(a) and 17(b), characteristics of embodiments of the invention are not affected at all. FIGS. 17(a) and 17(b) show diagrams corresponding to FIGS. 3(a) and 3(b), wherein FIG. 17(a) shows a schematic plane diagram, and FIG. 17(b) shows a schematic section diagram.

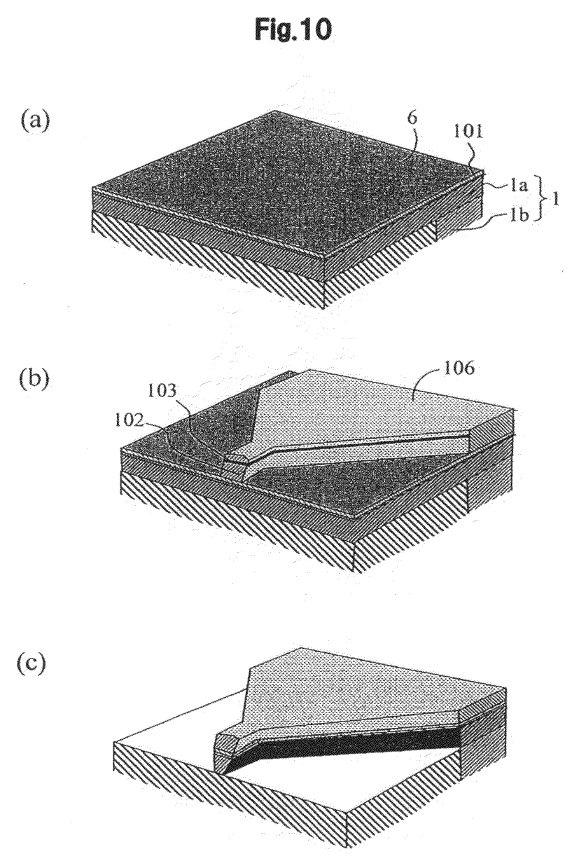

Hereinafter, a method of manufacturing the recording head of an embodiment of the invention is described. FIGS. 10(a) and 10(b), 11(a)-11(c), and 12(a)-12(c) show manufacturing process diagrams showing an example of the method of manufacturing the recording head of an embodiment of the invention.

FIGS. 10(a) and 10(b) show a manufacturing process of the pole tip 1a on which the main pole 1 and the nonmagnetic layer 6 are deposited in a condition that the yoke section 1b of the main pole 1 was manufactured, and then planarized by a CMP process. The yoke section 1b of the mail pole 1 is shown in the right of the figure. The left of the figure corresponds to the air-bearing surface side.

As shown in FIG. 10(a), a nonmagnetic cap layer 101 is deposited on a magnetic layer 1 to be a main pole, then heat treatment is performed for stabilizing the magnetic layer 1. Next, the nonmagnetic layer 6 for the second flare section is deposited. For the main pole 1, for example, a single-layer film or a multi-layer film of a magnetic body having high saturation magnetic flux density, which contains at least two elements of Co, Ni and Fe, can be used. The nonmagnetic cap layer is provided for protecting a trailing edge of the main pole, and for example, a single-layer film or a multi-layer film of an oxide or a nitride of Al, Si, Ta, Ti and the like, or a single-layer film or a multi-layer film of a nonmagnetic metal of Cr, NiCr, Rh, Mo, Nb, Au or the like can be used. The nonmagnetic layer 6 for the second flare section is provided for magnetically separating between the main pole and the second flare section, of which the thickness is 10 nm to 80 nm in the light of the field enhancement effect and the field gradient, and for example, a single-layer film or a multi-layer film of an oxide or a nitride of Al, Si, Ta, Ti or the like, or a single-layer film or a multi-layer film of a nonmagnetic metal of Cr, NiCr, Rh, Mo, Nb, Au or the like can be used.

Next, as shown in FIG. 10(b), an etching mask layer is formed on a top of the nonmagnetic layer 6 for the second flare section in the condition that the yoke section of the main pole was manufactured, and then planarized by a CMP process. The etching mask layer includes an etching layer 102 and a hard layer 103. For the etching layer 102, a resist is used, which has an enough thickness to act as a mask member before processing of the main pole is finished. For the hard layer 103, for example, a single-layer film or a multi-layer film of an oxide or a nitride of Al, Si, Ta, Ti or the like is used, which has a thickness at which the hard layer can be processed by a photo resist 106, in addition, at which the hard layer can be removed by ion milling processing before ion milling processing of the main pole 1 is finished. In the etching mask layer after processing, only the resist layer 102 is remained, which can be easily removed. The photo resist 106 is formed on the etching mask layer in accordance with a pattern of the main pole. A photo resist pattern 106 is transferred onto the hard mask layer 103 of the etching layer using a method of ion milling, RIE (Reactive Ion Etching), or RIM (Reactive Ion Milling). As a processing gas, for example, a single gas or a mixed gas of Ar, CF₄, CHF₃, SF₆ and the like is used. The transfer pattern is transferred to the etching layer 102 by the RIE method using a reactive gas being large in difference of selective etching rate. A single gas or a mixed gas of O₂, CO and CO₂ or the like is used as the reactive gas, thereby selective etching can be performed.

Next, as shown in FIG. 10(c), the nonmagnetic layer 6 for the second flare section, nonmagnetic cap layer 101, and main pole layer 1 are etched, so that a shape of an air-bearing surface of the main pole 1 is processed into an inverted trapezoidal shape. Then, the etching layer is removed.

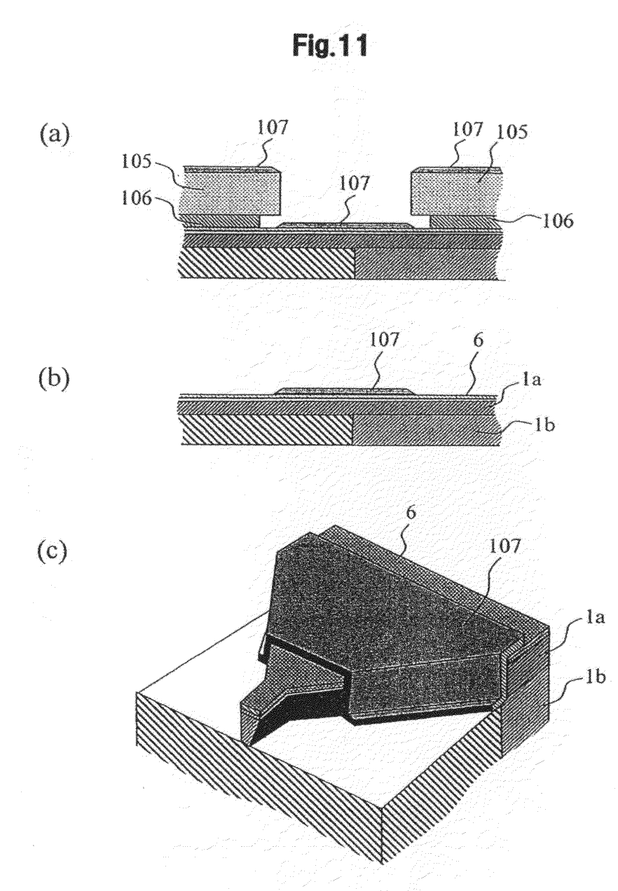

FIGS. 11(a) to 11(c) show schematic section diagrams and a perspective diagram respectively, showing a liftoff method for forming a magnetic body 107 of the second flare section on the main pole 1 by using liftoff. A two-layer resist for liftoff is configured by a lower part 106 including a non-photosensitive resist layer, and an upper part 1 05 including a photosensitive resist layer. In the case of a hollow pattern, as shown in FIG. 11(a), the upper resist 105 is formed in an overhang manner with respect to the lower resist 106. The magnetic body 107 is deposited on the two-layer resist pattern for liftoff by using a sputtering method.

FIG. 11(b) shows a schematic section diagram showing a condition after liftoff. FIG. 11(c) shows the second flare section 5 formed in the trailing side of the main pole 1, using a perspective diagram corresponding to a section of the section diagram.

Thickness of the magnetic body 107 is made to be 10 nm to 150 nm in the light of the field enhancement effect and the field gradient. As a material of the magnetic body, for example, a single-layer film or a multi-layer film of a magnetic material containing at least two elements of Co, Ni and Fe can be used. Moreover, as a position at which the magnetic body 107 is deposited, in the light of the field enhancement effect and the field gradient, a tip end portion at an air-bearing surface side of the second flare section 5 can be disposed in a position at a flare side, the position being 20 nm to 200 nm distant from the throat height zero at the air-bearing surface side in a depth direction. An unnecessary portion of the magnetic body 107 on a trailing side of the main pole 1 is removed by the liftoff method, so that the second flare section 5 is formed.

Next, a gap layer is formed to provide a shield for improving writing performance as one of factors that have influence on performance of a magnetic recording head. As shown in FIGS. 3(a) and 3(b), the shield surrounds the main pole from three sides. A gap layer using a nonmagnetic body is provided to magnetically separate between the shield 32 and the main pole 1. For depositing the gap layer including the nonmagnetic body, an apparatus is used, which is excellent in adhesion to a sidewall of a pattern, including a carousel sputter apparatus, an ion beam deposition apparatus, a CVD apparatus (Chemical Vapor Deposition), or an ALD apparatus (Atomic Layer Deposition), and the gap layer is deposited on the whole surface of a substrate. Next, processing is performed for determining thickness of the gap layer. Thickness of the gap layer on each sidewall of the main pole and the shield is desirably determined from thickness of the nonmagnetic body to be deposited. When thickness of the gap layer on each sidewall of the main pole and the shield is determined using ion milling, if ions are injected into the nonmagnetic layer on the sidewall in an incidence angle range of 50 to 70 degrees, a milling rate of the sidewall is increased. Regarding thickness of the gap layer between the trailing side of the main pole and the shield, when ions are injected in an incidence angle range of 30 to 60 degrees, a milling rate of an upper part can be increased, and a milling rate of the nonmagnetic layer on the sidewall can be decreased.

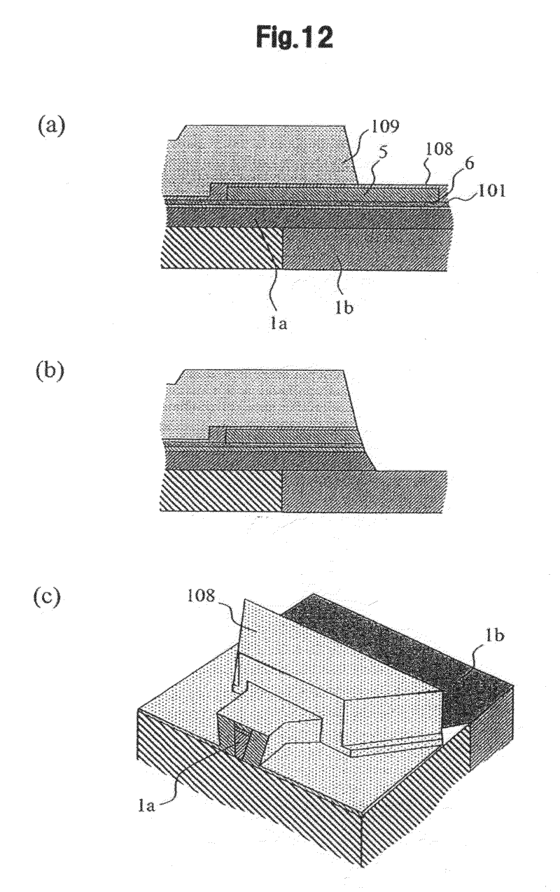

After that, as shown in FIGS. 2(a)-2(b) and 3(a)-3(b), a step of dividing the main pole 1 into the pole tip la and the yoke section 1b is performed. FIGS. 12(a) to 12(c) show schematic section diagrams of the step of dividing the main pole 1 into the pole tip 1a and the yoke 1b, and a perspective diagram corresponding to sections of the section diagrams, respectively. As shown in FIG. 12(a), a photo resist pattern 109 is formed by a photolithography method on a surface in which the pattern of the main pole 1 and the second flare section 5 are coated with the nonmagnetic body of the gap layer for shield 108. As shown in FIG. 12(b), using ion milling, the gap layer for shield 108, magnetic layer 5 of the second flare section 5, nonmagnetic layer 6, nonmagnetic cap layer 101, and main pole layer 1a are removed by the milling, so that the main pole 1 is divided into the pole tip 1a and the yoke 1b. FIG. 12(c) shows a perspective diagram showing a condition where the photo resist is removed. The pole tip 1a is coated with the nonmagnetic body except for an end portion at a pillar 17 side processed by ion milling. The second flare of an embodiment of the invention is also coated with the nonmagnetic body, and consequently a position of an end at the pillar 17 side of the second flare section 5 is determined.

According to the example, the deposition step of the magnetic body using liftoff is added to the usual main pole formation step, thereby the second flare section 5 can be formed. The second flare section 5 is provided on the pole tip 1a via the nonmagnetic layer 6 so that magnetic field strength is increased, thereby the increased magnetic field is distributed to shield enhancement while keeping a magnetic field necessary for writing into a recording medium, consequently writing blur can be suppressed, and field gradient can be improved.

Another example of a method of manufacturing the magnetic recording head of an embodiment of the invention is described. Here, only steps different from the steps shown in FIGS. 10 to 12 are described.

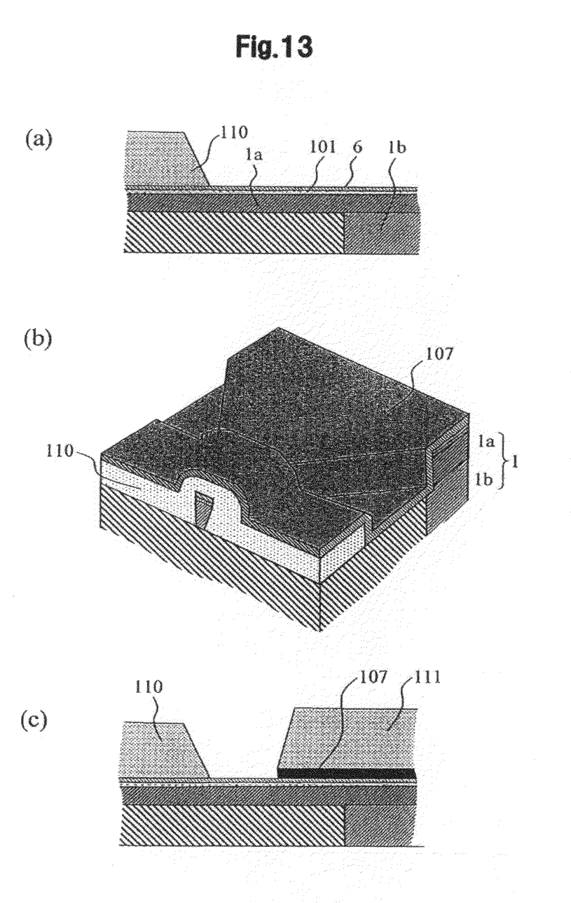

As shown in FIG. 10(c), the nonmagnetic layer 6 for the second flare section, nonmagnetic cap layer 101, and the magnetic layer of the main pole 1 are etched, so that a shape of the air-bearing surface of the main pole 1 is processed into an inverted trapezoidal shape, then the etching layer 102 is removed. Heretofore, steps are the same as the steps described before. Next, as shown in FIG. 13(a), a resist layer 110 is formed on a throat height region that defines writing width of the main pole 1. The resist layer I 10 is used to coat the throat height region of the main pole 1 for protection. Next, a magnetic layer 107 of the second flare section 5 is deposited on the whole surface of a substrate by a sputtering method. A condition that the magnetic layer 107 is deposited is shown in a perspective diagram of FIG. 13(b). As a material of a magnetic body, for example, a single-layer film or a multi-layer film of a magnetic material containing at least two elements of Co, Ni and Fe is used. Thickness of the magnetic body 107 is preferably made to be 10 nm to 150 nm in the light of the field enhancement effect and the field gradient.

Then, as shown in FIG. 13(c), a photo resist mask 111 for etching for ion milling is formed by photolithography. Regarding a position where the photo resist mask 111 is formed, the photo resist mask is disposed such that a tip end portion of the magnetic body of the second flare section 5 at the air-bearing surface side is formed in a position at a flare side 20 nm to 200 nm distant from the throat height zero at the air-bearing surface side in a depth direction. Using the photo resist 111 as a mask, an unnecessary magnetic body is removed by milling using ion milling, so that the second flare section 5 is formed. In the ion milling, an ion incidence angle is specified to be in a range of 45 degrees to 60 degrees. The ion incidence angle is preferable because redeposition due to milling is small. Since subsequent steps are the same as in FIGS. 12(a) to 12(c), description of them is omitted. According to the example, the position of the second flare section can be reproducibly formed.

Another example of a method of manufacturing the magnetic recording head of an embodiment of the invention is described. Here, only steps different from the steps shown in FIGS. 10 to 12 are described.

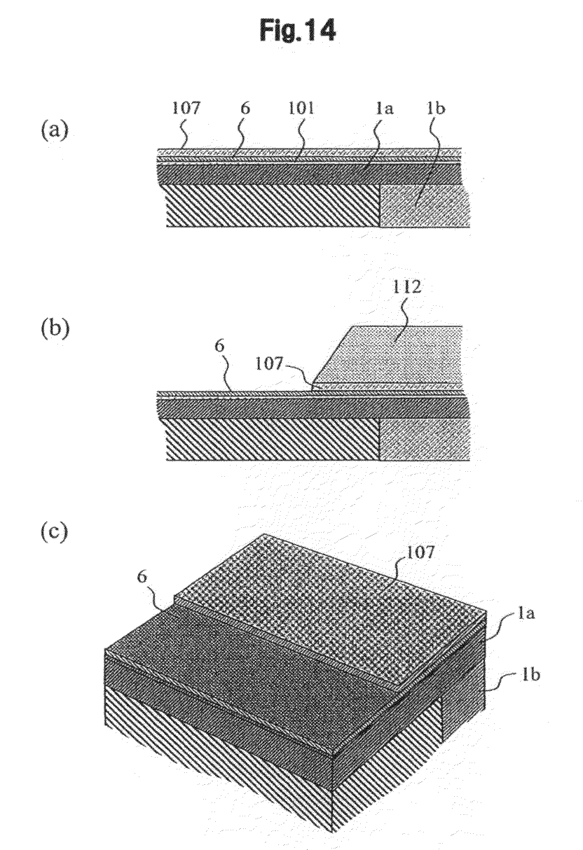

As shown in a schematic section diagram of FIG. 14(a), on a substrate in a condition that the yoke section 1b of the main pole 1 was manufactured and then planarized by a CMP process, the magnetic layer of the main pole 1, nonmagnetic cap layer 101, nonmagnetic layer 6, and magnetic layer 107 of the second flare section 5 were sequentially deposited, and then heat treatment was performed for stabilizing the magnetic layers. For the main pole 1, a single-layer film or a multi-layer film of a magnetic material having high saturation magnetic flux density, for example, a magnetic material containing at least two elements of Co, Ni and Fe, can be used. For the nonmagnetic cap layer 101, in order to protect a trailing edge of the main pole, for example, a single-layer film or a multi-layer film of an oxide or a nitride of Al, Si, Ta, Ti or the like can be used, or a single-layer film or a multi-layer film of a nonmagnetic metal such as Cr, NiCr, Rh, Mo, Nb and Au can be used. For the nonmagnetic layer 6, in order to magnetically separate between the main pole 1 and the second flare section 5, film thickness is specified to be 10 nm to 80 nm in the light of the field enhancement effect and the field gradient, and as a material, for example, a single-layer film or a multi-layer film of an oxide or a nitride of Al, Si, Ta, Ti or the like, or a single-layer film or a multi-layer film of a nonmagnetic metal such as Cr, NiCr, Rh, Mo, Nb and Au can be used. For the magnetic layer used for the second flare section 5, film thickness is specified to be 10 nm to 150 nm in the light of the field enhancement effect and the field gradient, and as a material, for example, a magnetic body in a single-layer film or a multi-layer film of a magnetic material containing at least two elements of Co, Ni and Fe can be used.

Next, as shown in FIG. 14(b), an etching mask pattern is formed by using the photo resist 112 on the magnetic layer 107 of the second flare section 5 in the condition that the yoke section 1b of the main pole 1 was manufactured and then planarized by the CMP process. Ion milling is performed using the photo resist 112 as a mask, thereby the magnetic body layer is removed by milling from the air-bearing surface side at the trailing side of the main pole in a range of 20 nm to 200 nm from the throat height zero at the air-bearing surface side of the magnetic layer 107 to an end, from which the second flare section is formed, at the air-bearing surface side in a flare side. The position at the air-bearing surface side of the second flare section 5 is determined in a condition that the substrate surface is planarized, thereby processing accuracy can be improved. The photo resist mask is removed, and consequently the position of the tip end portion at the air-bearing surface side of the magnetic body of the second flare section 5 is determined as shown in FIG. 14(c).

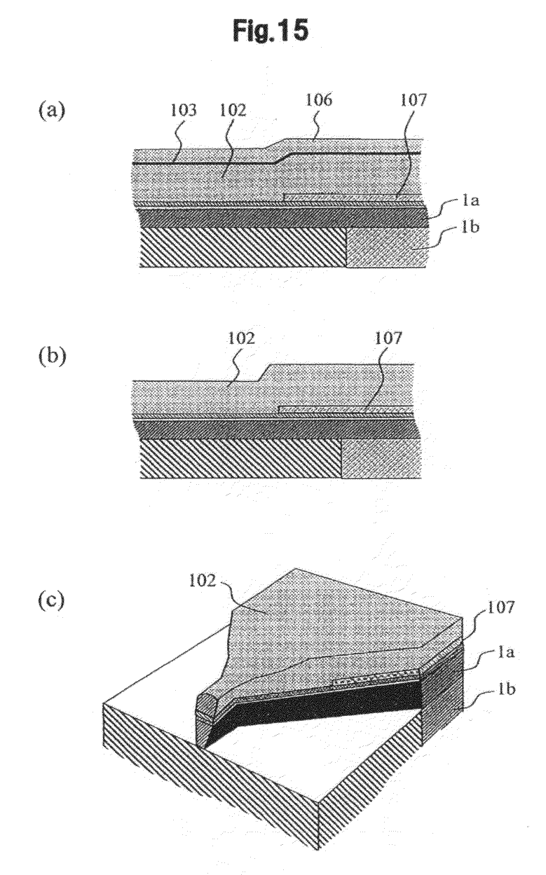

Then, as shown in FIG. 15(a), an etching mask layer is formed. The etching mask layer includes an etching layer 102 and a hard layer 103. For the etching layer 102, a resist is used, which has an enough thickness to act as a mask member before processing of the main pole is finished. As a material of the hard layer 103, for example, a single-layer film or a multi-layer film using an oxide or a nitride of Al, Si, Ta, Ti or the like is used, which has a thickness at which the hard layer can be processed by using a photo resist 106, in addition, at which the hard layer can be removed by ion milling processing before ion milling processing of the main pole 1 is finished. In the etching mask layer after processing of the main pole, only the etching layer 102 remains, which can be easily removed. The photo resist 106 is patterned on the etching mask layer in accordance with a pattern of the main pole. The photo resist pattern 106 is transferred to the hard mask layer 103 of the etching layer using ion milling, RIE (Reactive Ion Etching), or RIM (Reactive Ion Milling). As a processing gas, for example, a single gas or a mixed gas of Ar, CF₄, CHF₃, SF₆ or the like is used. Next, the transfer pattern of the hard mask layer 103 is transferred to the etching layer 102 of the etching mask layer using the RIE method, O₂, CO, CO₂ or the like is used as a reactive gas.

Next, FIG. 15(b) shows a schematic section diagram, and FIG. 15(c) shows a perspective diagram corresponding to a section of the section diagram. The magnetic layer 107 of the second flare section 5, nonmagnetic layer 6, nonmagnetic cap layer 101, and magnetic layer of the main pole 1 are etched, so that a pattern of the main pole and a shape at the air-bearing surface side of the main pole are processed into an inverted trapezoidal shape, and then the etching layer is removed.

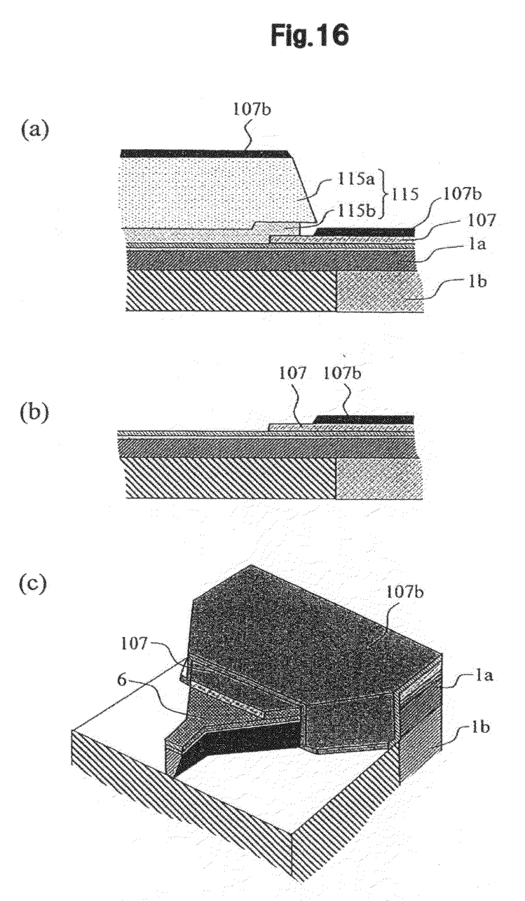

Then, as shown in FIG. 1 6(a), a liftoff pattern 115 for covering the magnetic body 107b is formed on each sidewall of the main pole by using a two-layer resist. Regarding a position of the liftoff pattern, a tip end portion of the magnetic body 107b is preferably deposited at a side near the pillar 17 compared with a tip end portion at the air-bearing surface side of the magnetic layer 107. The two-layer resist for liftoff is configured by a lower part 115b including a non-photosensitive resist layer, and an upper part 115a including a photosensitive resist layer. In the case of a hollow pattern, the upper resist 115a is formed in an overhang manner with respect to the lower resist 115b. In the trailing side of the second flare section 5, for example, a single-layer film or a multi-layer film of a magnetic material containing at least two elements of Co, Ni and Fe is deposited by using a sputtering method. FIG. 16(b) shows a schematic section diagram, and FIG. 16(c) shows a perspective diagram corresponding to a section of the section diagram. An unnecessary portion of the magnetic body is removed using the liftoff method so that the second flare section 5 is formed. Since subsequent steps are the same as in FIGS. 12(a) to 12(c), description of them is omitted.

In the case of the example, thickness of the magnetic body of the second flare section 5 deposited on each sidewall of the main pole is different from thickness of the magnetic body deposited in the trailing side of the main pole. Moreover, in the step of forming the second flare section 5, since the magnetic bodies are separately deposited, they are different in position at the air-bearing surface side. In order to obtain magnetic coupling for aligning a flow direction of magnetic flux between the main pole and the second flare section, the magnetic body on each sidewall of the main pole can be formed such that the tip end portion at the air-bearing surface side of the magnetic body 107b is formed at a side near the pillar 17 compared with the tip end portion at the air-bearing surface side of the magnetic layer 107. Moreover, even if thickness of the magnetic layer of the second flare section 5 is different between each sidewall of the main pole 1 and the trailing side of the main pole, enhancement of a recording field and increase in field gradient, which are features of the magnetic recording head of the invention, are not affected at all. In the case of the example, since the position of the tip end portion at the air-bearing surface side of the second flare section can be established in a flat condition before forming the main pole pattern, the position of the tip end portion at the air-bearing surface side of the second flare section can be accurately determined.

While the shape of the tip end portion at the air-bearing surface side of the second flare section 5 is parallel to the air-bearing surface as shown in FIGS. 2 and 3, even if the end has a tapered shape where thickness of the magnetic body is increased in a depth direction from the air-bearing surface at the trailing side of the second flare section 5 as shown in FIGS. 17(a) and 17(b), characteristics of embodiments of the invention are not affected.

What is claimed is:

1. A perpendicular magnetic recording head having:
a main pole,
an auxiliary pole,
a shield disposed at a trailing side of the main pole and on both sides in a track width direction of the main pole, and
a coil for generating a recording field from the main pole,
wherein the main pole has a throat height region that defines writing/recording width, and a flare section that is situated in an upper part in an element height direction with respect to the throat height region, and gradually expands in width toward an upside in the element height direction, and
wherein a second flare section is provided which includes a magnetic layer coated in a trailing side of the flare section via a non magnetic layer.

2. The perpendicular magnetic recording head according to claim 1, wherein the second flare section is coupled with sidewalls of the flare section.

3. The perpendicular magnetic recording head according to claim 1, wherein the second flare section comprises a magnetic material containing at least two elements selected from Co, Ni and Fe.

4. The perpendicular magnetic recording head according to claim 1, wherein a thickness of the second flare section is between about 10 nm to 150 nm.

5. The perpendicular magnetic recording head according to claim 1, wherein the second flare section has an end at an air-bearing surface side at a distance of between about 20 nm to 200 nm in the element height direction from a lower end of the flare section.

6. The perpendicular magnetic recording head according to claim 1, wherein a thickness of the nonmagnetic layer is between about 10 nm to 80 nm.

7. A magnetic recording/reproducing device comprising:
a magnetic disk recording medium rotationally configured to be rotationally driven by a motor;
a slider fixed to a tip of a suspension arm configured to be moveable onto a predetermined position on the magnetic disk recording medium; and
a thin film magnetic head formed on the slider, the thin film magnetic head comprising a perpendicular magnetic recording head having,
a main pole,
an auxiliary pole,
a shield disposed at a trailing side of the main pole and on both sides in a track width direction of the main pole, and
a coil for generating a recording field from the main pole,
wherein the main pole has a throat height region that defines writing/recording width, and a flare section that is situated in an upper part in an element height direction with respect to the throat height region, and gradually expands in width toward an upside in the element height direction, and
wherein a second flare section is provided which includes a magnetic layer coated in a trailing side of the flare section via a non magnetic layer.

8. The magnetic recording/reproducing device according to claim 7, wherein the second flare section is coupled with sidewalls of the flare section.

9. The magnetic recording/reproducing device according to claim 7, wherein the second flare section comprises a magnetic material containing at least two elements selected from Co, Ni and Fe.

10. The magnetic recording/reproducing device according to claim 7, wherein a thickness of the second flare section is between about 10 nm to 150 nm.

11. The magnetic recording/reproducing device according to claim 7, wherein the second flare section has an end at an air-bearing surface side at a distance of between about 20 nm to 200 nm in the element height direction from a lower end of the flare section.

12. The magnetic recording/reproducing device according to claim 7, wherein a thickness of the nonmagnetic layer is between about 10 nm to 80 nm.
